(19) United States
(12) Patent Application Publication
(10) Pub. No.: US 2026/0281549 A1
(43) Pub. Date: Sep. 17, 2026

(54) FOCUSING METHOD, CAMERA, AND STORAGE MEDIUM

(71) Applicant: Shenzhen Reolink Technology Co., Ltd., Shenzhen (CN)

(72) Inventors: Guixing Wang, Shenzhen (CN); Yusi Chen, Shenzhen (CN); Xing Xu, Shenzhen (CN)

(21) Appl. No.: 19/663,528

(22) Filed: Apr. 30, 2026

(30) Foreign Application Priority Data
May 7, 2025 (CN) 202510591112.7

(51) Int. Cl. H04N 23/67; H04N 23/56

(52) U.S. Cl. CPC H04N 23/671; H04N 23/56

(57) ABSTRACT

The embodiments of the present disclosure relate to a focusing method, a camera, and a computer-readable storage medium. The focusing method includes: acquiring state information corresponding to a target component in a camera; determining, when change in state information are detected, target focusing information corresponding to a current time from a corresponding relationship between associated state information and focusing information based on the change; and adjusting an image plane position of the camera based on the target focusing information to make imaging of the camera clear. The present disclosure can directly calculate and determine the image plane capable of realizing clear imaging, currently based on the working state of the camera itself and the target focusing information.

This application claims a priority of the Chinese patent application with application number 202510591112.7, filed with the China National Intellectual Property Administration on May 7, 2025, and titled “Focusing Method, Camera, and Storage Medium,” the entire content of which is incorporated herein by reference.

### TECHNICAL FIELD

The present disclosure relates to the field of imaging system control technology, and particularly relates to a focusing method, a camera, and a computer-readable storage medium.

### BACKGROUND

Day and night defocus phenomenon refers to the phenomenon that the main light source wavelength changes in the process of day-to-night alternation, which results in the change of the image plane, and makes an image changed from clear blur after the change of the image plane. In the related art, the above described changes due to the day and night defocus phenomenon are compensated mainly by adjusting the image plane using an automatic focusing lens. However, the automatic focusing process often causes a loss in the resolution or time-consuming.

### SUMMARY

The present disclosure provides a focusing method, a camera, and a computer-readable storage medium.

The Focusing Method involved in the embodiments of the present disclosure is applied to a Camera, and the method includes: acquiring state information corresponding to a target component in a camera; determining target focusing information corresponding to a current moment from a corresponding relationship associating the state information and focusing information based on the change when a change in state information is detected; and adjusting an image plane position of the camera based on the target focusing information to make the imaging of the camera clear.

In this way, the present disclosure can directly calculate and determine the image plane capable of realizing clear imaging, currently based on the working state of the camera itself and the target focusing information. That is to say, the present disclosure can, based on the relationship between the working state of the camera itself and the main light source wavelength, and the correlation between the change in the main light source wavelength and the change in the target focusing information, directly realize the determination of the target focusing information and further adjust the image plane position to complete focusing, thereby reducing the time for re-completing focusing in the case of day and night defocus so as to restore the image to be clear.

In some embodiments, the determining target focusing information from a corresponding relationship associating the state information and focusing information based on the change includes: determining a target focusing direction corresponding to the current moment from the corresponding relationship based on the change; the adjusting an image plane position of the camera based on the target focusing information includes: adjusting the image plane position of the camera based on the target focusing direction.

In some embodiments, the adjusting the image plane position of the camera based on the target focusing direction includes: traversing each image plane along the focusing direction, and comparing imaging clarity between adjacent image planes based on a one-way hill-climbing algorithm to obtain a comparison result; determining an image plane position with the highest imaging clarity as a target image plane position according to the comparison result; and adjusting the image plane position of the camera to the target image plane position.

In some embodiments, determining target focusing information corresponding to a current moment from a corresponding relationship associating the state information and focusing information based on the change when a change in state information is detected includes: determining a first camera focal length and a current image plane position of the camera according to a first state information before the change in state information, and determining a current object distance of the camera according to the first camera focal length and the current image plane position; determining target focusing information after the change in state information according to the object distance and the corresponding relationship between the state information and focusing information, wherein the corresponding relationship is a pre-calibrated corresponding relationship between the object distance and the image plane position under a condition of different main light source wavelengths.

In some embodiments, determining target focusing information corresponding to a current moment from a corresponding relationship associating the state information and focusing information based on the change when a change in state information is detected includes: acquiring a first main light source wavelength before the change in state information; determining the second main light source wavelength after the change in state information, in the case where a change in the main light source wavelength is detected; determining the current image plane position of the camera according to the first state information before the change in state information; determining an object distance of the camera based on a corresponding relationship between the state information and focusing information according to the current image plane position and the first main light source wavelength, wherein the corresponding relationship is a pre-calibrated corresponding relationship between the object distance and the image plane position under a condition of different main light source wavelengths; determining the target focusing information based on the corresponding relationship according to the second main light source wavelength and the object distance.

In some embodiments, the determining the varied main light source wavelength includes: acquiring the second main light source wavelength based on a main light source wavelength detection device; and/or, acquiring an image picture corresponding to a current moment, and determining color information about the image picture according to the image picture; determining the second main light source wavelength from a preset corresponding relationship associated with the color information and the main light source wavelength based on the color information.

In some embodiments, the main light source includes monochromatic light or mixed light, when the main light source includes mixed light, that the first main light source wavelength and/or the second main light source wavelength include/includes the average wavelength of the mixed light, or the first main light source wavelength and/or the second main light source wavelength include/includes the wavelength with highest intensity in the light source spectrum.

In some embodiments, the state information includes an open state and a closed state, the target component includes an infrared cut or an infrared light source, and the changes include a change of the infrared cut from the open state to the closed state, and a change of the infrared cut from the closed state to the open state.

In some embodiments, the camera includes a memory and a processor, the memory has stored there on a computer program which, when executed by the processor, implements the focusing method described above.

In some embodiments, the computer-readable storage medium has stored there on a computer program which, when executed by one or more processors, implements the focusing method described above.

Additional aspects and advantages of embodiments of the present disclosure will be set forth in part in the description which follows and, in part, will be obvious from the description, or may be learned by practice of embodiments of the present disclosure.

### BRIEF DESCRIPTION OF THE DRAWINGS

The accompanying drawings herein are incorporated into and constitute a part of this specification, illustrate embodiments consistent with the present disclosure, and together with the specification serve to explain the principles of the present disclosure.

In order to more clearly illustrate the technical solutions in the embodiments of the present disclosure or in the prior art, the following will briefly introduce the drawings required for use in the description of the embodiments or the prior art. Obviously, for those of ordinary skill in the art, other drawings can be obtained based on these drawings without creative effort.

FIG. 1 is a first schematic flow chart of a focusing method according to an embodiment of the present disclosure;

FIG. 2 is a second schematic flow chart of the focusing method according to an embodiment of the present disclosure;

FIG. 3 is a third schematic flow chart of the focusing method according to an embodiment of the present disclosure;

FIG. 4 is a fourth schematic flow chart of the focusing method according to an the embodiment of the present disclosure.

### DETAILED DESCRIPTION

In order to understand the above purposes, features, and advantages of the present disclosure more clearly, the solution of the present disclosure will be further described below. It should be noted that, in the case of no conflict, the embodiments of the present disclosure and the features in the embodiments can be combined with each other.

In the following description, many specific details are set forth to facilitate a full understanding of the present disclosure. However, the present disclosure can also be implemented in other ways different from those described herein. Obviously, the embodiments in the specification are only a part of the embodiments of the present disclosure, not all of them.

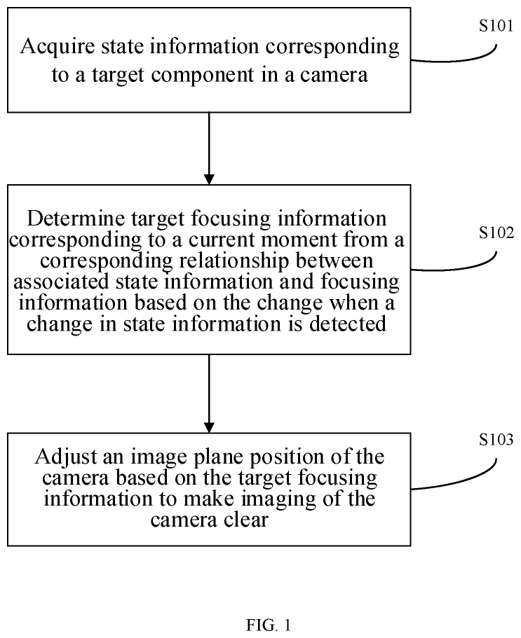

With reference to FIG. 1, the focusing method in the embodiment of the present disclosure is applied to a camera, and the method specifically includes the following steps:
S101: state information corresponding to a target component in a camera is acquired;
S102: target focusing information corresponding to a current moment is determined from a mapping between the state information and focusing information based on the change when changes in state information are detected;
S103: an image plane position of the camera is adjusted based on the target focusing information to achieve clear imaging of the camera.

In some embodiments, the state information includes an open state and a closed state, the target component includes an infrared cut or an infrared light source, and the changes include a change of the infrared cut from the open state to the closed state, and a change of the infrared cut from the closed state to the open state.

A camera, according to an embodiment of the present disclosure, may implement the focusing method described above. Specifically, the camera includes a memory and a processor, wherein the memory stores a computer program, and the processor is used for acquiring state information corresponding to target components in the camera, and for determining, when a change in state information is detected, target focusing information corresponding to a current moment from a mapping between the state information and the focusing information based on the change, and for adjusting an image plane position of the camera based on the target focusing information to achieve clear imaging of the camera.

Specifically, the focusing method in the embodiment of the present disclosure is applied to a camera. Wherein the above-mentioned camera includes devices such as a camera used for monitoring, security, and other fields, and the above-mentioned camera supports an infrared ray light supplement function when working at night or in an environment where other light sources are insufficient. The above-mentioned target focusing information includes the image plane information for maximizing the imaging clarity of the camera under the current light source conditions.

On this basis, the focusing method mainly determines the target focusing information according to the state information of the target component itself on the camera, wherein the target component generally includes an Infrared Cut (IR-CUT) or an infrared light source, the state information of the target component generally includes an open state and a closed state, and the change of the state information generally refers to the change of the target component from the on state to the off state, or the change of the state information from the off state to the on state. For example, for an IR-CUT, the corresponding main light source is infrared when the IR-CUT is in the open state and visible when the IR-CUT is in the closed state. Next, in the case where the camera detects change in state information of the target component, the camera invokes the mapping between the above-mentioned state information and the focusing information calibrated before leaving the factory, and determines the above-mentioned target focusing information based on the change in state information of the above-mentioned target component, and directly adjusts the current image plane of the camera to the image plane with the highest imaging clarity of the camera under the current light source condition according to the target focusing information so as to complete the focusing process. Compared with the phase focusing method in the prior art, the focusing method in the present disclosure directly calculates the image plane position according to the acquired working state and the position information about the image plane, without setting a phase pixel point, and without causing a resolution loss. Compared with the current contrast focusing method in the relevant art, the focusing method in the present disclosure does not need to perform non-targeted traversal analysis in a plurality of candidate image planes, and only needs to directly obtain the correlation and corresponding relationship between the acquired change in state information and pre-calibration, that is to say, the image plane position with the highest imaging clarity can be obtained, then the time required for focusing can be greatly saved, and the running fluency of the camera can be improved.

In this way, in the present disclosure, the image plane capable of realizing clear imaging can be directly calculated and determined based on the working state of the camera itself and the target focusing information. That is to say, in the present disclosure, based on the relationship between the working state of the camera itself and the main light source wavelength, and the correlation between the change in the main light source wavelength and the change in the target focusing information, the determination of the target focusing information is directly realized and further the image plane position is adjusted to complete focusing, thereby the time for re-completing focusing for restoring the image to be clear is reduced in the case of day and night defocus.

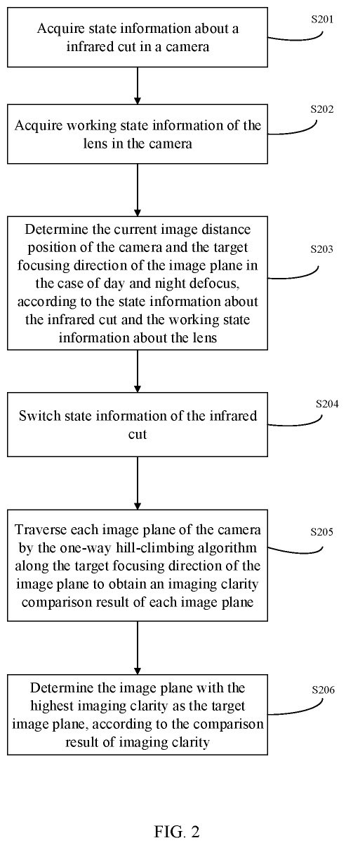

In order to explain in more detail the actual implementation process of the Focusing Method in the above-mentioned embodiment, reference is further made to FIG. 2, and FIG. 2 shows a specific implementation flow example of the Focusing Method, that is, the Focusing Method in the embodiment of the present disclosure can be implemented according to the following steps:
S201: state information of an infrared cut in a camera is acquired.

Specifically, an infrared cut (IR-CUT) is generally used to optimize the imaging effect of the device under different main light source conditions by switching different filters. IR-CUT is generally composed of an infrared cut filter (IR Cut Filter) and a full-spectrum optical glass, and the two light-transmitting plates are switched by circuit control.

IR-CUT has two main states. When daytime or visible light is sufficient, the IR-CUT is switched and positioned to operate with an infrared cut filter, i.e., the IR-CUT is currently operating in day mode. The above-mentioned infrared cut filter can prevent infrared light from passing through and allow visible light to pass through, so as to enable the video image acquired by the camera to restore a real color and avoid the interference of infrared light on the color restoration, and at this time, the main working light source of the camera is visible light. In the nighttime or when the visible light is insufficient, the IR-CUT controls the infrared cut filter to automatically move away, so as to switch and position the full spectrum optical glass to operate, that is to say, the IR-CUT currently operates in the night mode. In this way, the camera can sense the infrared light emitted by the infrared light supplementing device, thus greatly improving the night vision performance of the camera, and at this time, the main working light source of the camera is infrared light.

Then, based on the above-mentioned example, before the target image plane is determined in the case of day and night defocus, firstly the state information of the IR-CUT in the camera is acquired in the current state, wherein the above-mentioned state information includes the current operation mode information of the IR-CUT, that is to say, the operation mode of the IR-CUT, either a day mode or a night mode, is included.
S202: working state information of a lens in a camera is acquired.

Wherein the working state information of the lens is stored before the camera leaves the factory, and the working state information about the lens includes a corresponding relationship between the state information about the infrared cut and the changing direction of the imaging of the image sensor.

Specifically, based on the above-mentioned embodiment, in addition to the operating state of the IR-CUT, exemplarily, the working state information of a lens in a camera is acquired before a target image plane is determined in the case of day and night defocus. The working state information is an attribute of the lens itself and is stored in the memory of the device immediately before the camera is shipped from the factory. The working state information about the lens includes a first corresponding relationship between an operating state of the IR-CUT and a changing direction of imaging of an image sensor in the camera. Since the main cause of the day and night defocus phenomenon is the wavelength change of the main light source, and there is a fixed correlation between the main light source wavelength and the image distance (equivalent to the image plane position) when the camera is fixed, the above correlation is equivalent to the corresponding relationship between the main light source wavelength of the camera and the adjustment direction of the image plane.
S203: the current image distance position of the camera and the target focusing direction of the image plane in the case of day and night defocus is determined according to the state information of the infrared cut and the working state information of the lens.

Specifically, based on the above-mentioned embodiment, acquisition of the current operating mode of the IR-CUT is equivalent to the acquisition of the main light source wavelength of the current camera, and then the image distance of the camera in different operating modes of the IR-CUT, namely, different main light source wavelengths can be further determined based on the acquired working state information about the lens, and the imaging position of the camera in the different main light source wavelengths can be further determined. In addition, based on the acquired working state information of the lens, the target focusing direction of the image plane adjustment required to improve the imaging clarity in the case of day and night defocus can be further determined.
S204: state information of the infrared cut is switched.

Specifically, based on the above-described embodiment, the focusing process can be started at any time, in case all preparatory work has been completed. The specific execution of the focusing process starts from the switching of the working state of the IR-CUT, and after the working state of the IR-CUT is switched from the current working state contained in the acquired first working state information to another working state, the camera can determine the image plane according to the target focusing direction obtained through the above-mentioned steps.
S205: each image plane of the camera is traversed by the one-way hill-climbing algorithm along the target focusing direction of the image plane to obtain an imaging clarity comparison result of each image plane;

Specifically, based on the above-mentioned embodiment, in the case where the working state of the IR-CUT has been switched, starting from the current image plane of the camera, image plane screening is performed along the above-mentioned target focusing direction by means of a one-way hill-climbing algorithm, and since there are a correlation between the image distance and the main light source wavelength and a corresponding correlation between the image plane and the image distance at the same time, the above-mentioned image plane screening can only be performed along the target focusing direction within a range specified by the correlation between the image plane and the image distance, so that the time consumption of a rough search process can be reduced. It is more time-saving than the hill-climbing algorithm used in the contrast focusing method in the related art at present.

For example, in the case where the operating state of the IR-CUT is switched from the day operating mode to the night operating mode, each image plane is first traversed along the determined target focusing direction in accordance with a pre-set step length, and the comparison result of the imaging clarity between two adjacent image planes is compared. Illustratively, the above-mentioned comparison result may be a numerical result obtained by using the difference between the imaging clarity of the previous image plane and that of the subsequent image plane. Next, the target image plane position may be calculated by analyzing each of the obtained comparison results further based on a one-way hill-climbing algorithm.
S206: the image plane with the highest imaging clarity is determined as the target image plane according to the comparison result of imaging clarity.

Specifically, based on the above-mentioned example, the target image plane position can be obtained by analyzing the sign of each imaging clarity comparison result along the target focusing direction based on the one-way hill-climbing algorithm. Generally, when traversing from the image plane closest to the camera to the target image plane, the imaging clarity of each image plane becomes higher and higher, the difference between the imaging clarity of the former and the latter from two adjacent image planes is negative, and the imaging clarity reaches the highest in a certain range near the target image plane, and then a downward trend occurs, then the imaging clarity difference becomes positive in the above-mentioned range. Then, the image plane corresponding to the sign change point of the difference in imaging clarity can be determined as the target image plane.

Next, the camera can perform focusing according to the determined target image plane, and adjust the position of its own image plane to the position where the target image plane is located, thereby completing the focusing in the case of day and night defocusing.

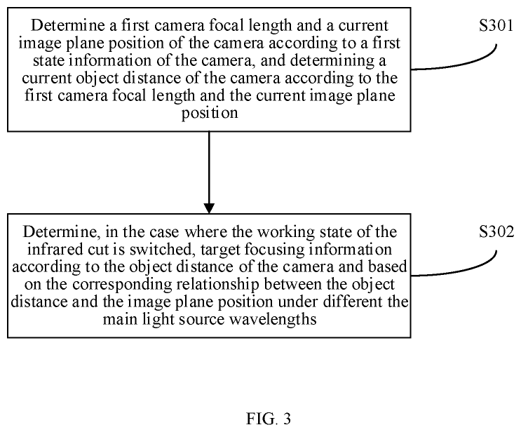

With further reference to FIG. 3, FIG. 3 shows a specific implementation flow example of the focusing method, that is to say, the focusing method in the embodiment of the present disclosure can be implemented according to the following steps:

First, it should be noted that in some special scenes, such as indoors, the change of the main light source is predictable, i.e. it is necessary to switch between a main light source having a first wavelength corresponding to a case where the IR-CUT of the camera is operating in a daytime state and a main light source having a second wavelength corresponding to a case where the IR-CUT of the camera is operating in a nighttime state. It is therefore possible to calibrate the image plane position with the highest imaging clarity for different object distances at different main light source wavelengths before the camera leaves the factory to form a second corresponding relationship, and to save the second corresponding relationship between the calibrated object distance and the image plane in the form of data in the memory of the camera so as to be recalled when focusing control is executed.
S301: a first camera focal length and a current image plane position of the camera are determined according to a first state information of the camera, and a current object distance of the camera is determined according to the first camera focal length and the current image plane position.

Specifically, in some examples, the current camera operates normally, and it can be assumed that the current camera operates normally under the condition of the main light source of the first wavelength, and at this time, the current image plane position of the camera can be obtained according to the corresponding relationship between the first wavelength and the image plane position, and the image plane position is equivalent to the current image distance of the camera, and the current image distance of the camera can be obtained according to the unique corresponding image plane position.

On this basis, in the case where the camera can clearly image at present, a focal length information (corresponding to the first camera focal length) of the camera under the condition of a first wavelength and a current image plane position (equivalent to a current image distance) of the camera can be obtained according to a current working state of the camera (including a first wavelength and a working state corresponding to IR-CUT), and then according to a known focal length information of the camera itself under the condition of the first wavelength and the current image distance, based on the corresponding relationship among the image distance v, the object distance u and the focal length f:

$$\frac{1}{f} = \frac{1}{u} + \frac{1}{v}$$

In the case where the focal length f is a focal length information of the camera itself, and the image distance v is a known current image distance, the object distance u can be determined as the current object distance of the camera. Next, the image plane position after focusing is completed can be calculated according to the current object distance.
S302: in the case where the working state of the infrared cut is switched, target focusing information is determined according to the object distance of the camera and based on the corresponding relationship between the object distance and the image plane position under different main light source wavelengths.

Specifically, based on the above-mentioned embodiment, focusing is realized in the case of day and night defocusing, and a switching condition of state information about a camera is also required to be acquired, wherein the above-mentioned state information about the camera includes current operation mode information about the IR-CUT, for example, first state information about the camera corresponds to the IR-CUT operating in a daytime state, and second state information about the camera corresponds to the IR-CUT operating in a nighttime state, etc. However, based on the above-mentioned embodiment, the corresponding main light source wavelength is a first wavelength when the IR-CUT is operated in a daytime state, and the corresponding main light source wavelength is a second wavelength when the IR-CUT is operated in a nighttime state.

It can be assumed that before the change in state information of the camera, the IR-CUT is normally operated in a daytime state, and at this time, according to step S301, the current object distance of the camera can be determined. Then when the state information about the camera changes, the IR-CUT switches the working state to the night state, and since the object distance can be considered to be unchanged when the camera works indoors, according to a second corresponding relationship between the object distance and the image plane position under the condition of a pre-calibrated second wavelength, target focusing information can be correspondingly obtained based on the camera object distance before the state information about the camera is switched, wherein the target focusing information contains one piece of image plane position information; the image plane position information is the position information corresponding to the image plane having the highest imaging clarity at the second wavelength and at the camera object distance before the state information of the camera is switched, and then the image plane is the target image plane capable of achieving the highest imaging clarity.

It should be additionally noted that since the first wavelength and the second wavelength are preset and known values, the execution of step S302 can be performed either in the case where the working state of IR-CUT is switched as described above, or performed in advance when the Camera works normally and the working state of IR-CUT is not switched. When step S302 is executed in advance when the Camera works normally and the working state of IR-CUT is not switched, step S302 is equivalent to preparing data for focusing in advance.

Next, in the case where the target focusing information has been determined, the camera adjusts the image plane to the target image plane position and focusing can be completed. Specifically, if step S302 is performed in the case where the operation state of the IR-CUT is switched, the focusing process may be performed immediately after the target focusing information is obtained through the execution of step S302. If step S302 is executed in advance when the camera is working normally and the working state of the IR-CUT is not switched, then the specific execution of the focusing process starts from the switching of the working state of the IR-CUT, and after the working state of the IR-CUT is switched from the current working state to another working state, the main light source wavelength is switched accordingly, and the camera directly adjusts the image plane of the camera to the position corresponding to the image plane position information contained in the target focusing information according to the target focusing information obtained in the above-mentioned embodiment, thereby completing the focusing process. In this way, the time taken for the camera to refocus in the case of day and night defocus is substantially shifted to a pre-factory stage, and in actual use, the time taken for the image blur caused by the light source change can be greatly shortened in a special scene in which the main light source wavelength is relatively fixed, such as in a room.

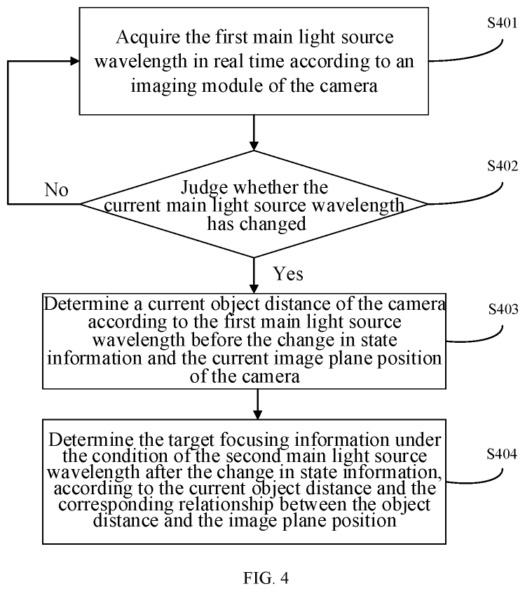

With further reference to FIG. 4, FIG. 4 shows a specific implementation flow example of the focusing method, that is to say, the focusing method in the embodiment of the present disclosure can be implemented according to the following steps:

First, it is to be noted that, similarly to the above-described embodiment, the corresponding relationship between the object distance and the image plane position having the highest imaging clarity can be calibrated as a third corresponding relationship in advance under a variety of different main light source wavelengths before the camera is shipped from the factory, and the third corresponding relationship is stored in the camera memory in the form of data as intrinsic information of the camera, so as to be recalled when focusing is performed. In the above-mentioned calibration corresponding relationship, the more kinds of main light source wavelengths, the more corresponding positions of the obtained image planes under the condition of the same object distance, and then the more accurate positions of the subsequently obtained target image planes under the condition of a larger number of screenable image planes.
S401: the first main light source wavelength is acquired in real time according to an imaging module of the camera.

Specifically, based on the above-mentioned embodiment, based on the current operation of the camera, the camera can acquire the current main light source wavelength (namely, the first main light source wavelength) based on the picture acquired in the current viewing range.

Illustratively, the imaging module of the camera is provided with a main light source wavelength detection device, which typically makes a direct measurement of the main light source by means of a sensor in the environment in which the camera is located.

Furthermore, by way of example, color information about a picture can also be acquired by colors in an imaging module according to the picture of a current viewing range, and then, according to the color information, a first main light source wavelength of a current camera is obtained based on a corresponding relationship associated with the color information and the main light source wavelength. It is noted that by way of example, the three actions of acquiring the picture information in the current viewing range, acquiring the color information of the picture based on the imaging module, and roughly judging the current first main light source wavelength from the color information are continuous, with the aim of continuously monitoring the change in the main light source wavelength.
S402: whether the current main light source wavelength has changed is determined, if yes, the process proceeds to step S403, and if no, the process returns to step S401.

Specifically, based on the above-mentioned embodiment, in the process of continuously judging the current first main light source wavelength, there may be a relatively small or a relatively large difference between the first main light source wavelengths judged according to two adjacent frames of pictures, and considering that there is a certain error range when judging whether there is a change in the main light source wavelength according to the color information, when judging whether there is a change in the first main light source wavelength corresponding to two adjacent frames of pictures, for example, a wavelength difference threshold value or this wavelength difference threshold value range may be set. And when the difference between the main light source wavelengths corresponding to two adjacent frame pictures is less than or equal to the above-mentioned wavelength difference threshold value, or is within the above-mentioned wavelength difference threshold value range, it is considered that there is no change between the main light source wavelengths corresponding to two adjacent frame pictures. On the other hand, when the difference between the main light source wavelengths corresponding to two adjacent frames of pictures is greater than the above-mentioned wavelength difference threshold, or is outside the above-mentioned wavelength difference threshold range, it is considered that the main light source wavelengths corresponding to two adjacent frames of pictures have changed.

Furthermore, in the case where there is no change between the wavelengths of the main light source corresponding to two adjacent frames, the process of detecting and judging the current main light source wavelength continues. In addition, in the case where the main light source wavelengths corresponding to two adjacent frames of pictures change, it can be determined at this moment that the situation of day and night defocus is entered, and focusing is required. When a change in the main light source wavelength is detected, the changed main light source wavelength is the second main light source wavelength.

It is to be noted here that the main light source in the environment may be monochromatic light, such as red light, blue light, infrared light of a certain frequency, etc., or it may be mixed light, such as white light. When the ambient main light source is a mixed light, the first main light source wavelength and the second main light source wavelength in the above-mentioned examples may be the average wavelength of the mixed light or the wavelength corresponding to the part of the mixed light spectrum with the highest light intensity.
S403: a current object distance of the camera is determined according to the first main light source wavelength before the change in state information and the current image plane position of the camera.

Specifically, based on the above-mentioned embodiment, in the case where a change in the main light source wavelength is detected, the state information of the camera changes accordingly, for example, the operating state of the IR-CUT is switched. In this case, the camera can determine the current object distance of the camera according to the third corresponding relationship between the object distance and the image plane position under different conditions of the main light source wavelengths which are pre-calibrated before leaving the factory, and based on the condition of the first main light source wavelength before the change, according to the image plane position of the camera before the state information switch.

Specifically, in the case where the imaging module of the camera detects that the main light source wavelength of the environment changes from the first main light source wavelength to the second main light source wavelength, the operating state of the IR-CUT is switched firstly, and in response to the above-mentioned switching action, the camera firstly acquires current image plane position information, and then the camera determines object distance information corresponding to the above-mentioned image plane position information as the current object distance of the camera under the condition of the first main light source wavelength based on a pre-calibrated third corresponding relationship.
S404: the target focusing information is determined under the condition of the second main light source wavelength after the change in state information, according to the current object distance and the corresponding relationship between the object distance and the image plane position.

Specifically, based on the above-mentioned embodiment, further, in the case where the current object distance is known, since the operating environment of the camera does not change, it can be considered that the current object distance of the camera does not change, while the main light source wavelength of the environment has changed from the first main light source wavelength to the second main light source wavelength. Then, according to the above-mentioned third corresponding relationship between the object distance and the image plane position, the camera can obtain the target focusing information corresponding to the current object distance of the camera under the condition of the second main light source wavelength, wherein the target focusing information includes the target image plane position information corresponding to the current object distance under the condition of the second main light source wavelength, and the position is the image plane position with the highest imaging clarity after the main light source wavelength changes in the case of day and night defocus.

Next, in the case where the target focusing information has been determined, the camera adjusts the image plane to the target image plane position and focusing can be completed. In this way, the time taken for the camera to refocus in the case of day and night defocus is substantially shifted to a pre-factory stage, and the acquired picture can be used to detect the change of the wavelength of the current main light source in the process of actual use, and the target image plane position can be quickly determined correspondingly in the case of the change of the main light source wavelength, and the image plane can be directly adjusted to the above-mentioned position, so as to greatly shorten the image blurring time caused by the light source change.

A computer-readable storage medium in accordance with embodiments of the present disclosure stores a computer program that, when executed by one or more processors, implements the above-described focusing method.

In the descriptions of this specification, reference terms such as “some embodiments”, “in one example”, or “illustratively” indicate that the specific features, structures, materials, or characteristics described in connection with the embodiments or examples are included in at least one embodiment or example of the present disclosure. In this specification, schematic depictions of the above terms do not necessarily refer to the same embodiment or example. Furthermore, the particular features, structures, materials, or characteristics described may be combined in any suitable manner in any one or more of the embodiments or examples. Furthermore, combinations and sub combinations of the various embodiments or examples and features of the various embodiments or examples described in this specification can be made by one skilled in the art without departing from the spirit and scope of the invention.

Any process or method description in a flowchart or otherwise described herein may be understood to represent a module, segment, or portion of code, which includes one or more executable instructions for implementing the steps of a particular logical function or process, and the scope of the preferred embodiments of the present disclosure includes additional implementations, which may perform functions in substantially the same way or in a reverse order, depending on the functionality involved, out of the order shown or discussed, as would be understood by those reasonably skilled in the art to which the embodiments of the present disclosure pertain.

While embodiments of the present disclosure have been shown and described, it is to be understood that the above-described embodiments are illustrative and not restrictive, and that changes, modifications, substitutions, and variations may be made in the above-described embodiments by one of ordinary skill in the art without departing from the scope of the present disclosure.

What is claimed is:

1. A focusing method for a camera, comprising:
acquiring state information associated with a target component of the camera;
in response to detecting a change in the state information, determining a target focusing information for a current time based on a mapping between the state information and focusing information; and
adjusting an image plane position of the camera based on the target focusing information.

2. The method according to claim 1, wherein the target focusing information comprises a target focusing direction, and wherein the adjusting the image plane position comprises:
adjusting the image plane position in the target focusing direction.

3. The method according to claim 2, wherein the adjusting the image plane position comprises:
traversing candidate image planes along the target focusing direction;
obtaining a comparison result by comparing imaging clarity between adjacent candidate image planes based on a one-way hill-climbing algorithm;
determining an image plane position with a highest imaging clarity as a target image plane position according to the comparison result; and
adjusting the image plane position to the target image plane position.

4. The method according to claim 1, wherein the in response to detecting the change in the state information, determining the target focusing information for the current time based on the mapping between the state information and focusing information comprises:
determining a first camera focal length and a current image plane position of the camera according to a first state information before the change in the state information, and determining a current object distance of the camera according to the first camera focal length and the current image plane position; and
determining the target focusing information after the change in the state information according to the current object distance and the mapping between the state information and focusing information, wherein the mapping between the state information and focusing information is a pre-calibrated mapping between an object distance and an image plane position under a condition of different main light source wavelengths.

5. The method according to claim 1, wherein the change in the state information comprises a change in a main light source wavelength, wherein the mapping between the state information and focusing information is a pre-calibrated mapping between an object distance and an image plane position for different wavelengths; wherein the in response to detecting the change in the state information, determining the target focusing information for the current time based on the mapping between the state information and focus information comprises:
acquiring a first main light source wavelength before the change;
acquiring a second main light source wavelength after the change;
determining a current image plane position according to the first main light source wavelength;
determining an object distance based on the current image plane position, the first main light source wavelength and a pre-calibrated mapping between the object distance and the image plane position for different wavelengths; and
determining the target focusing information based on the second main light source wavelength and the object distance.

6. The method according to claim 5, wherein the determining the second main light source wavelength comprises:
detecting the second main light source wavelength using a wavelength detection device.

7. The method according to claim 5, wherein the determining the second main light source wavelength comprises:
acquiring an image for a current time, and determining color information of the image;
determining the second main light source wavelength from a preset relationship between a color information and a light source wavelength.

8. The method according to claim 5, wherein the main light source comprises monochromatic light or mixed light, and when the main light source comprises mixed light, the first main light source wavelength and/or the second main light source wavelength comprises an average wavelength of the mixed light.

9. The method according to claim 5, wherein the main light source comprises monochromatic light or mixed light; wherein the first main light source wavelength and/or the second main light source wavelength comprises a wavelength with a highest spectral intensity.

10. The method according to claim 1, wherein the state information comprises an open state or a closed state;
wherein the target component comprises an infrared-cut filter or an infrared light source, and
the change in the state information comprises switching the infrared-cut filter between the open state and the closed state.

11. A camera, comprising:
a memory storing instructions; and
one or more processors is configured to execute the instructions to perform processes of:
acquiring state information associated with a target component of the camera;
in response to detecting a change in the state information, determining a target focusing information for a current time based on a mapping between the state information and focusing information; and
adjusting an image plane position of the camera based on the target focusing information.

12. The camera according to claim 11, wherein the target focusing information comprises a target focusing direction, and wherein the adjusting the image plane position comprises:
adjusting the image plane position in the target focusing direction.

13. The camera according to claim 12, wherein the adjusting the image plane position comprises:
traversing candidate image planes along the target focusing direction;
obtaining a comparison result by comparing imaging clarity between adjacent candidate image planes based on a one-way hill-climbing algorithm;
determining an image plane position with a highest imaging clarity as a target image plane position according to the comparison result; and
adjusting the image plane position to the target image plane position.

14. The camera according to claim 11, wherein the in response to detecting the change in the state information, determining the target focusing information for the current time based on the mapping between the state information and focusing information comprises:
determining a first camera focal length and a current image plane position of the camera according to a first state information before the change in the state information, and determining a current object distance of the camera according to the first camera focal length and the current image plane position; and
determining the target focusing information after the change in the state information according to the current object distance and the mapping between the state information and focusing information, wherein the mapping between the state information and focusing information is a pre-calibrated mapping between an object distance and an image plane position under a condition of different main light source wavelengths.

15. The camera according to claim 11, wherein the change in the state information comprises a change in a main light source wavelength, wherein the mapping between the state information and focusing information is a pre-calibrated mapping between an object distance and an image plane position for different wavelengths; wherein the in response to detecting a change in the state information, determining a target focusing information for a current time based on a mapping between the state information and focus information comprises:
acquiring a first main light source wavelength before the change;
acquiring a second main light source wavelength after the change;
determining a current image plane position according to the first main light source wavelength;
determining an object distance based on the current image plane position, the first main light source wavelength and a pre-calibrated mapping between the object distance and the image plane position for different wavelengths; and
determining the target focusing information based on the second main light source wavelength and the object distance.

16. The camera according to claim 15, wherein the determining the second main light source wavelength comprises:
detecting the second main light source wavelength using a wavelength detection device.

17. The camera according to claim 15, wherein the determining the second main light source wavelength comprises:
acquiring an image for a current time, and determining color information of the image;
determining the second main light source wavelength from a preset relationship between a color information and a light source wavelength.

18. The camera according to claim 15, wherein the main light source comprises monochromatic light or mixed light, and when the main light source comprises mixed light, the first main light source wavelength and/or the second main light source wavelength comprises an average wavelength of the mixed light.

19. The camera according to claim 15, wherein the main light source comprises monochromatic light or mixed light; wherein the first main light source wavelength and/or the second main light source wavelength comprises a wavelength with a highest spectral intensity.

20. A non-transitory computer-readable storage medium, wherein the non-transitory computer-readable storage medium has stored thereon a computer program which, when executed by one or more processors, implements the focusing method of: acquiring state information associated with a target component of the camera;
in response to detecting a change in the state information, determining a target focusing information for a current time based on a mapping between the state information and focusing information; and
adjusting an image plane position of the camera based on the target focusing information.
